(19) United States
(12) Patent Application Publication
(10) Pub. No.: US 2024/0236438 A1
(43) Pub. Date: Jul. 11, 2024

(54) DISPLAY APPARATUS AND OPERATING METHOD THEREFOR

(71) Applicant: LG ELECTRONICS INC., Seoul (KR)

(72) Inventor: Yunam KIM, Seoul (KR)

(73) Assignee: LG ELECTRONICS INC., Seoul (KR)

(21) Appl. No.: 18/565,424

(22) PCT Filed: Jun. 2, 2021
(86) PCT No.: PCT/KR2021/006848

§ 371 Date: Nov. 29, 2023

(51) Int. Cl. H04N 21/488; H04N 5/278; H04N 21/485

(52) U.S. Cl. CPC H04N 21/488; H04N 5/278; H04N 21/4854

(57) ABSTRACT

A display device according to an embodiment of the present disclosure may comprise: a display configured to display an image and a subtitle corresponding to the image; and a control unit configured to receive a search command for changing a playback point of the image, wherein the control unit is further configured to: change the playback point of the image to a subtitle unit according to the search command, and change the playback point differently according to an inter-subtitle interval.

### TECHNICAL FIELD

The present disclosure relates to a display device and a method of operating the same, and more specifically, to change the playback location according to a search command when playing an image.

### BACKGROUND ART

Recently, digital TV service using wired or wireless communication network has become popular. Digital TV service may provide a variety of service that cannot be provided by existing analog broadcasting service.

For example, IPTV (Internet Protocol Television), a type of digital TV service, and smart TV service provide interactivity that allows user to actively select the type of program to watch and the viewing time. IPTV and smart TV services may provide various additional services, such as Internet search, home shopping, and online games, based on this interactivity.

Meanwhile, when the display device receives a signal for pressing the direction key provided on the remote control while playing video, it may move the playback point forward or backward. However, in the conventional case, because the playback point moves at fixed time interval, the playback point may move to a point while the characters in the image are speaking, making it difficult to change the playback point to listen from the beginning of the dialogue.

Meanwhile, Republic of Korea Patent Publication No. 10-2009-0075439 discloses a method of moving the playback point to unit of the search sync value and then changing it to the start location of the subtitle closest to the movement point. However, according to the conventional method, there is a problem in that the user has to set the search sync value directly, and in this case, the search sync value is set too large and a specific subtitle is skipped, or it is set too small, so the same subtitle start location is continuously changed. In addition, there may be a mix of case where subtitle is frequently changed to a short form and case where the subtitle is slowly changed to a long form. Due to the fixed search sync value, there is a problem in that the playback location is changed inconsistently and irregularly when searching playback location.

On the other hand, when changing the playback location to the starting point of the previous subtitle or the starting point of the next subtitle, there is an inconvenience in that the dialogue starts immediately after changing the playback location.

### DISCLOSURE

### Technical Problem

The present disclosure seeks to minimize the problem where the playback point of the image is changed to between the conversation of the character in the image.

The present disclosure seeks to minimize the problem of lingering in a specific subtitle when changing the playback point of the image on a subtitle unit.

The present disclosure allows user to easily select sentence to be output when a video is played for language learning purposes.

### Technical Solution

A display device according to an embodiment of the present disclosure may comprise a display configured to display an image and a subtitle corresponding to the image; and a control unit configured to receive a search command for changing a playback point of the image, wherein the control unit is further configured to: change the playback point of the image to a subtitle unit according to the search command, and change the playback point differently according to an inter-subtitle interval.

wherein the control unit may change the playback point from a start point of a current subtitle to a point before a reference time when the search command is a first search command that changes the playback point forward than a current point.

wherein the control unit may change the playback point from a start point of a following subtitle to a point before a reference time when the search command is a second search command that changes the playback point backward than a current point.

wherein the control unit may change the playback point from a start point of a current subtitle to a point before a reference time, when the search command is a first search command that changes the playback point forward than a current point, and change the playback point from a start point of a following subtitle to a point before the reference time when the search command is a second search command that changes the playback point backward than the current point.

wherein the control unit may adjust the reference time based on the inter-subtitle interval.

wherein the control unit may set the reference time to a time corresponding to half of the interval when the inter-subtitle interval is less than a set time, and set the reference time to a time corresponding to a preset constant when the inter-subtitle interval is longer than the set time.

wherein the first search command may be a left key input command provided in the remote control device, and the second search command may be a right key input command provided in the remote control device.

wherein the control unit may change the playback point to a start point of a subtitle closest to a selected point when the search command is a command to select a point on a progress bar indicating the playback point.

wherein the control unit may display a menu for selecting either a subtitle search mode or a general search mode.

wherein the control unit may change the playback point of the image to the subtitle unit when the subtitle search mode is set, and change the playback point of the image to a preset fixed time unit when the general search mode is set.

wherein the control unit may display a notification of setting a search mode in which the playback point of the image is changed to the subtitle unit when a language of an audio output according to the image and a language of the subtitle are different.

wherein the control unit may display a notification of setting a search mode in which the playback point of the image is changed to the subtitle unit when a language of an audio output according to the image and a language of the subtitle are same.

### Advantageous Effects

According to an embodiment of the present disclosure, since the playback point of the image is changed in subtitle unit, there is an advantage in that the problem of conversation interruption when the playback point is changed is minimized.

According to an embodiment of the present disclosure, since the playback point is determined in unit of subtitle, there is an advantage in minimizing the problem of the playback point being repeatedly changed to the location of a specific subtitle when a search command is given.

According to an embodiment of the present disclosure, the playback point is determined according to the interval between subtitles, so problems such as the playback point being changed while skipping specific lines or the playback point being changed too far ahead of the start point of the line are minimized. In other words, by determining the playback point based on the interval between subtitles, there is an advantage in that the problem of skipping specific lines is minimized and the playback point is changed so that the line starts immediately upon change.

According to an embodiment of the present disclosure, there is an advantage of facilitating language learning for user through image. In other words, since the playback point is changed in unit of subtitle, it is easy to repeatedly play back specific line, so the playback point may be changed efficiently for language learning.

According to an embodiment of the present disclosure, there is an advantage of being able to change scene without audio interruption.

### DESCRIPTION OF DRAWINGS

FIG. 1 is a block diagram illustrating a configuration of a display device according to an embodiment of the present disclosure.

FIG. 2 is a block diagram illustrating a remote control device according to an embodiment of the present invention.

FIG. 3 is a view illustrating an actual configuration of a remote control device according to an embodiment of the present invention.

FIG. 4 is a view of utilizing a remote control device according to an embodiment of the present invention.

FIG. 5 is a control block diagram illustrating a method in which a display device changes the playback point of an image according to a search command according to an embodiment of the present disclosure.

FIG. 6 is an example diagram of subtitle sync blocks constituting a subtitle file.

FIG. 7 is a flow chart illustrating a method of operating a display device according to an embodiment of the present disclosure.

FIG. 8 is an example diagram illustrating a method by which a display device sets a playback point on a subtitle unit according to an embodiment of the present disclosure.

FIG. 9 is a diagram illustrating a method of changing the playback location on a subtitle unit according to an embodiment of the present disclosure.

FIG. 10 is a diagram showing how the playback location changes between lines when a search command is received according to an embodiment of the present disclosure.

FIG. 11 is an example diagram illustrating a method of setting a playback location in a display device according to an embodiment of the present disclosure to minimize the problem of dialogue interruption when the playback location is specified.

FIG. 12 is a flowchart illustrating a method by which a display device sets a method of changing a playback location according to a search command according to an embodiment of the present disclosure.

FIG. 13 is an example diagram illustrating a method of displaying a subtitle setting menu by a display device according to an embodiment of the present disclosure.

FIG. 14 is a flowchart illustrating a method of outputting a notification in which a display device induces a change of an operation mode based on an audio language and a subtitle language according to an embodiment of the present disclosure.

FIG. 15 is an example diagram illustrating a notification output by a display device based on an audio language and a subtitle language according to an embodiment of the present disclosure.

### BEST MODE

Hereinafter, embodiments relating to the present disclosure will be described in detail with reference to the drawings. The suffixes “module” and “unit” for components used in the description below are assigned or mixed in consideration of easiness in writing the specification and do not have distinctive meanings or roles by themselves.

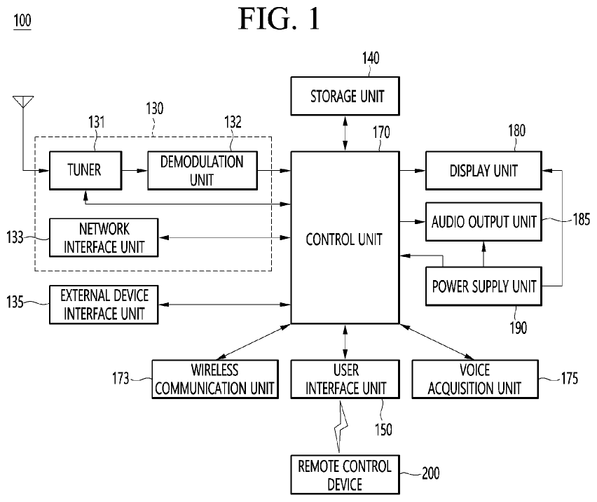

FIG. 1 is a block diagram illustrating a configuration of a display device according to an embodiment of the present invention.

Referring to FIG. 1, a display device 100 may include a broadcast reception unit 130, an external device interface unit 135, a storage unit 140, a user interface unit 150, a control unit 170, a wireless communication unit 173, voice acquisition unit 175, a display unit 180, an audio output unit 185, and a power supply unit 190.

The broadcast reception unit 130 may include a tuner 131, a demodulation unit 132, and a network interface unit 133.

The tuner 131 may select a specific broadcast channel according to a channel selection command. The tuner 131 may receive broadcast signals for the selected specific broadcast channel.

The demodulation unit 132 may divide the received broadcast signals into video signals, audio signals, and broadcast program related data signals and restore the divided video signals, audio signals, and data signals to an output available form.

The network interface unit 133 may provide an interface for connecting the display device 100 to a wired/wireless network including the Internet network. The network interface unit 133 may transmit or receive data to or from another user or another electronic device through an accessed network or another network linked to the accessed network.

The network interface unit 133 may access a predetermined webpage through an accessed network or another network linked to the accessed network. That is, the network interface unit 133 may transmit or receive data to or from a corresponding server by accessing a predetermined webpage through the network.

Then, the network interface unit 133 may receive contents or data provided from a content provider or a network operator. That is, the network interface unit 133 may receive contents such as movies, advertisements, games, VODs, and broadcast signals, which are provided from a content provider or a network provider, through network and information relating thereto.

Additionally, the network interface unit 133 may receive firmware update information and update files provided from a network operator and transmit data to an Internet or content provider or a network operator.

The network interface unit 133 may select and receive a desired application among applications open to the air, through network.

The external device interface unit 135 may receive an application or an application list in an adjacent external device and deliver it to the control unit 170 or the storage unit 140.

The external device interface unit 135 may provide a connection path between the display device 100 and an external device. The external device interface unit 135 may receive at least one an image or audio output from an external device that is wirelessly or wiredly connected to the display device 100 and deliver it to the control unit 170. The external device interface unit 135 may include a plurality of external input terminals. The plurality of external input terminals may include an RGB terminal, at least one High Definition Multimedia Interface (HDMI) terminal, and a component terminal.

An image signal of an external device input through the external device interface unit 135 may be output through the display unit 180. A sound signal of an external device input through the external device interface unit 135 may be output through the audio output unit 185.

An external device connectable to the external device interface unit 135 may be one of a set-top box, a Blu-ray player, a DVD player, a game console, a sound bar, a smartphone, a PC, a USB Memory, and a home theater system, but this is just exemplary.

Additionally, some of the content data stored in the display device 100 may be transmitted to a selected user or selected electronic device among other users or other electronic devices pre-registered in the display device 100.

The storage unit 140 may store signal-processed image, voice, or data signals stored by a program in order for each signal processing and control in the control unit 170.

Additionally, the storage unit 140 may perform a function for temporarily storing image, voice, or data signals output from the external device interface unit 135 or the network interface unit 133 and may store information on a predetermined image through a channel memory function.

The storage unit 140 may store an application or an application list input from the external device interface unit 135 or the network interface unit 133.

The display device 100 may play content files (for example, video files, still image files, music files, document files, application files, and so on) stored in the storage unit 140 and provide them to a user.

The user interface unit 150 may deliver signals input by a user to the control unit 170 or deliver signals from the control unit 170 to a user. For example, the user interface unit 150 may receive or process control signals such as power on/off, channel selection, and screen setting from the remote control device 200 or transmit control signals from the control unit 170 to the remote control device 200 according to various communication methods such as Bluetooth, Ultra Wideband (WB), ZigBee, Radio Frequency (RF), and IR.

Additionally, the user interface unit 150 may deliver, to the control unit 170, control signals input from local keys (not shown) such as a power key, a channel key, a volume key, and a setting key.

Image signals that are image-processed in the control unit 170 may be input to the display unit 180 and displayed as an image corresponding to corresponding image signals. Additionally, image signals that are image-processed in the control unit 170 may be input to an external output device through the external device interface unit 135.

Voice signals processed in the control unit 170 may be output to the audio output unit 185. Additionally, voice signals processed in the control unit 170 may be input to an external output device through the external device interface unit 135.

Besides that, the control unit 170 may control overall operations in the display device 100.

Additionally, the control unit 170 may control the display device 100 by a user command or internal program input through the user interface unit 150 and download a desired application or application list into the display device 100 in access to network.

The control unit 170 may output channel information selected by a user together with processed image or voice signals through the display unit 180 or the audio output unit 185.

Additionally, according to an external device image playback command received through the user interface unit 150, the control unit 170 may output image signals or voice signals of an external device such as a camera or a camcorder, which are input through the external device interface unit 135, through the display unit 180 or the audio output unit 185.

Moreover, the control unit 170 may control the display unit 180 to display images and control broadcast images input through the tuner 131, external input images input through the external device interface unit 135, images input through the network interface unit, or images stored in the storage unit 140 to be displayed on the display unit 180. In this case, an image displayed on the display unit 180 may be a still image or video and also may be a 2D image or a 3D image.

Additionally, the control unit 170 may play content stored in the display device 100, received broadcast content, and external input content input from the outside, and the content may be in various formats such as broadcast images, external input images, audio files, still images, accessed web screens, and document files.

Moreover, the wireless communication unit 173 may perform a wired or wireless communication with an external electronic device. The wireless communication unit 173 may perform short-range communication with an external device. For this, the wireless communication unit 173 may support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication unit 173 may support wireless communication between the display device 100 and a wireless communication system, between the display device 100 and another display device 100, or between networks including the display device 100 and another display device 100 (or an external server) through wireless area networks. The wireless area networks may be wireless personal area networks.

Herein, the other display device 100 may be a mobile terminal such as a wearable device (for example, a smart watch, a smart glass, and a head mounted display (HMD)) or a smartphone, which is capable of exchanging data (or inter-working) with the display device 100. The wireless communication unit 173 may detect (or recognize) a communicable wearable device around the display device 100. Furthermore, if the detected wearable device is a device authenticated to communicate with the display device 100, the control unit 170 may transmit at least part of data processed in the display device 100 to the wearable device through the wireless communication unit 173. Accordingly, a user of the wearable device may use the data processed in the display device 100 through the wearable device.

The voice acquisition unit 175 may acquire audio. The voice acquisition unit may include at least one microphone (not shown) and acquire audio of adjacent of display device 100 through a microphone (not shown)

The display unit 180 may convert image signal, data signal, or on-screen display (OSD) signal, which are processed in the control unit 170, or images signal or data signal, which are received in the external device interface unit 135, into R, G, and B signals to generate driving signal.

Furthermore, the display device 100 shown in FIG. 1 is just one embodiment of the present invention and thus, some of the components shown may be integrated, added, or omitted according to the specification of the actually implemented display device 100.

That is, if necessary, two or more components may be integrated into one component or one component may be divided into two or more components and configured. Additionally, a function performed by each block is to describe an embodiment of the present invention and its specific operation or device does not limit the scope of the present invention.

According to another embodiment of the present invention, unlike FIG. 1, the display device 100 may receive images through the network interface unit 133 or the external device interface unit 135 and play them without including the tuner 131 and the demodulation unit 132.

For example, the display device 100 may be divided into an image processing device such as a set-top box for receiving broadcast signals or contents according to various network services and a content playback device for playing contents input from the image processing device.

In this case, an operating method of a display device according to an embodiment of the present invention described below may be performed by one of the display device described with reference to FIG. 1, an image processing device such as the separated set-top box, and a content playback device including the display unit 180 and the audio output unit 185.

The audio output unit 185 receives the audio-processed signal from the control unit 170 and outputs it as audio.

The power supply unit 190 supplies the corresponding power throughout the display device 100. In particular, power may be supplied to the control unit 170, which may be implemented in the form of a system on chip (SOC), the display unit 180 for displaying images, and the audio output unit 185 for audio output.

Specifically, the power supply unit 190 may include a converter that converts alternating current power to direct current power and a dc/dc converter that converts the level of direct current power.

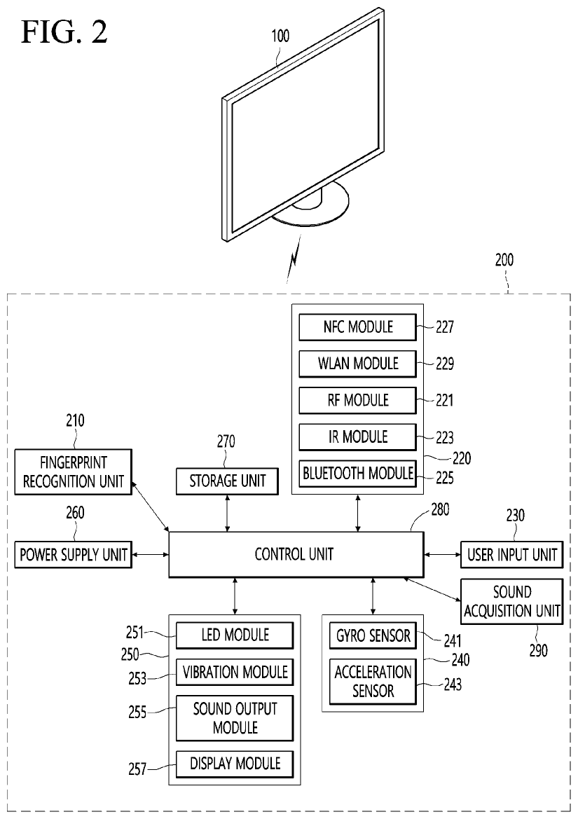

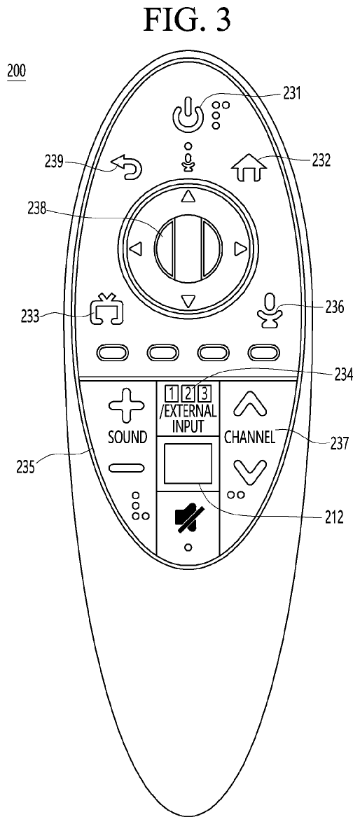

Then, referring to FIGS. 2 and 3, a remote control device is described according to an embodiment of the present invention.

FIG. 2 is a block diagram illustrating a remote control device according to an embodiment of the present invention and FIG. 3 is a view illustrating an actual configuration of a remote control device according to an embodiment of the present invention.

First, referring to FIG. 2, a remote control device 200 may include a fingerprint recognition unit 210, a wireless communication unit 220, a user input unit 230, a sensor unit 240, an output unit 250, a power supply unit 260, a storage unit 270, a control unit 280, and a sound acquisition unit 290.

Referring to FIG. 2, the wireless communication unit 220 transmits/receives signals to/from an arbitrary any one of display devices according to the above-mentioned embodiments of the present invention.

The remote control device 200 may include a radio frequency (RF) module 221 for transmitting/receiving signals to/from the display device 100 according to the RF communication standards and an IR module 223 for transmitting/receiving signals to/from the display device 100 according to the IR communication standards. Additionally, the remote control device 200 may include a Bluetooth module 225 for transmitting/receiving signals to/from the display device 100 according to the Bluetooth communication standards. Additionally, the remote control device 200 may include a Near Field Communication (NFC) module 227 for transmitting/receiving signals to/from the display device 100 according to the NFC communication standards and a WLAN module 229 for transmitting/receiving signals to/from the display device 100 according to the Wireless LAN (WLAN) communication standards.

Additionally, the remote control device 200 may transmit signals containing information on a movement of the remote control device 200 to the display device 100 through the wireless communication unit 220.

Moreover, the remote control device 200 may receive signals transmitted from the display device 100 through the RF module 221 and if necessary, may transmit a command on power on/off, channel change, and volume change to the display device 100 through the IR module 223.

The user input unit 230 may be configured with a keypad button, a touch pad, or a touch screen. A user may manipulate the user input unit 230 to input a command relating to the display device 100 to the remote control device 200. If the user input unit 230 includes a hard key button, a user may input a command relating to the display device 100 to the remote control device 200 through the push operation of the hard key button. This will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a voice adjustment button 235, a voice recognition button 236, a channel change button 237, a check button 238, and a back button 239.

The fingerprint recognition button 212 may be a button for recognizing a user's fingerprint. According to an embodiment of the present invention, the fingerprint recognition button 212 may perform a push operation and receive a push operation and a fingerprint recognition operation. The power button 231 may be button for turning on/off the power of the display device 100. The home button 232 may be a button for moving to the home screen of the display device 100. The live button 233 may be a button for displaying live broadcast programs. The external input button 234 may be a button for receiving an external input connected to the display device 100. The voice adjustment button 235 may be a button for adjusting the size of a volume output from the display device 100. The voice recognition button 236 may be a button for receiving user's voice and recognizing the received voice. The channel change button 237 may be a button for receiving broadcast signals of a specific broadcast channel. The check button 238 may be a button for selecting a specific function and the back button 239 may be a button for returning to a previous screen.

Again, explains FIG. 2.

If the user input unit 230 includes a touch screen, a user may touch a soft key of the touch screen to input a command relating to the display device 100 to the remote control device 200. Additionally, the user input unit 230 may include various kinds of input means manipulated by a user, for example, a scroll key and a jog key, and this embodiment does not limit the scope of the present invention.

The sensor unit 240 may include a gyro sensor 241 or an acceleration sensor 243 and the gyro sensor 241 may sense information on a movement of the remote control device 200.

For example, the gyro sensor 241 may sense information on an operation of the remote control device 200 on the basis of x, y, and z axes and the acceleration sensor 243 may sense information on a movement speed of the remote control device 200. Moreover, the remote control device 200 may further include a distance measurement sensor and sense a distance with respect to the display unit 180 of the display device 100.

The output unit 250 may output image or voice signals in response to manipulation of the user input unit 230 or image or voice signals corresponding to signals transmitted from the display device 100. A user may recognize whether the user input unit 230 is manipulated or the display device 100 is controlled through the output unit 250.

For example, the output unit 250 may include an LED module 251 for flashing, a vibration module 253 for generating vibration, a sound output module 255 for outputting sound, or a display module 257 for outputting an image, if the user input unit 230 is manipulated or signals are transmitted/received to/from the display device 100 through the wireless communication unit 220.

Additionally, the power supply unit 260 supplies power to the remote control device 200 and if the remote control device 200 does not move for a predetermined time, stops the power supply, so that power waste may be reduced. The power supply unit 260 may resume the power supply if a predetermined key provided at the remote control device 200 is manipulated.

The storage unit 270 may store various kinds of programs and application data necessary for control or operation of the remote control device 200. If the remote control device 200 transmits/receives signals wirelessly through the display device 100 and the RF module 221, the remote control device 200 and the display device 100 transmits/receives signals through a predetermined frequency band.

The control unit 280 of the remote control device 200 may store, in the storage unit 270, information on a frequency band for transmitting/receiving signals to/from the display device 100 paired with the remote control device 200 and refer to it.

The control unit 280 controls general matters relating to control of the remote control device 200. The control unit 280 may transmit a signal corresponding to a predetermined key manipulation of the user input unit 230 or a signal corresponding to movement of the remote control device 200 sensed by the sensor unit 240 to the display device 100 through the wireless communication unit 220.

Additionally, the sound acquisition unit 290 of the remote control device 200 may obtain voice.

The sound acquisition unit 290 may include at least one microphone and obtain voice through the microphone 291.

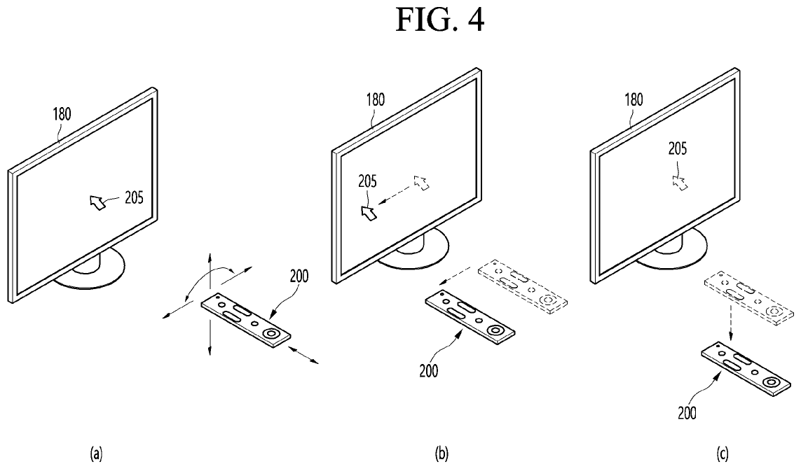

Next, FIG. 4 will be described.

FIG. 4 is a view of utilizing a remote control device according to an embodiment of the present invention.

FIG. 4(a) illustrates that a pointer 205 corresponding to the remote control device 200 is displayed on the display unit 180.

A user may move or rotate the remote control device 200 vertically or horizontally. The pointer 205 displayed on the display unit 180 of the display device 100 corresponds to a movement of the remote control device 200. Since the corresponding pointer 205 is moved and displayed according to a movement on a 3D space as show in the drawing, the remote control device 200 may be referred to as a spatial remote control device.

FIG. 4(b) illustrates that if a user moves the remote control device 200, the pointer 205 displayed on the display unit 180 of the display device 100 is moved to the left according to the movement of the remote control device 200.

Information on a movement of the remote control device 200 detected through a sensor of the remote control device 200 is transmitted to the display device 100. The display device 100 may calculate the coordinates of the pointer 205 from the information on the movement of the remote control device 200. The display device 100 may display the pointer 205 to match the calculated coordinates.

FIG. 4(c) illustrates that while a specific button in the remote control device 200 is pressed, a user moves the remote control device 200 away from the display unit 180. Thus, a selection area in the display unit 180 corresponding to the pointer 205 may be zoomed in and displayed larger.

On the other hand, if a user moves the remote control device 200 close to the display unit 180, a selection area in the display unit 180 corresponding to the pointer 205 may be zoomed out and displayed in a reduced size.

On the other hand, if the remote control device 200 is moved away from the display unit 180, a selection area may be zoomed out and if the remote control device 200 is moved closer to the display unit 180, a selection area may be zoomed in.

Additionally, if a specific button in the remote control device 200 is pressed, recognition of a vertical or horizontal movement may be excluded. That is, if the remote control device 200 is moved away from or closer to the display unit 180, the up, down, left, or right movement cannot be recognized and only the back and forth movement may be recognized. While a specific button in the remote control device 200 is not pressed, only the pointer 205 is moved according to the up, down, left or right movement of the remote control device 200.

Moreover, the moving speed or moving direction of the pointer 205 may correspond to the moving speed or moving direction of the remote control device 200.

Furthermore, a pointer in this specification means an object displayed on the display unit 180 in response to an operation of the remote control device 200. Accordingly, besides an arrow form displayed as the pointer 205 in the drawing, various forms of objects are possible. For example, the above concept includes a point, a cursor, a prompt, and a thick outline. Then, the pointer 205 may be displayed in correspondence to one point of a horizontal axis and a vertical axis on the display unit 180 and also may be displayed in correspondence to a plurality of points such as a line and a surface.

Meanwhile, the display device 100 may play an image, and when playing an image, the display 180 may display the image and a subtitle corresponding to the image, and the audio output unit 185 may output audio corresponding to the image.

The control unit 170 may receive a search command for the image being played.

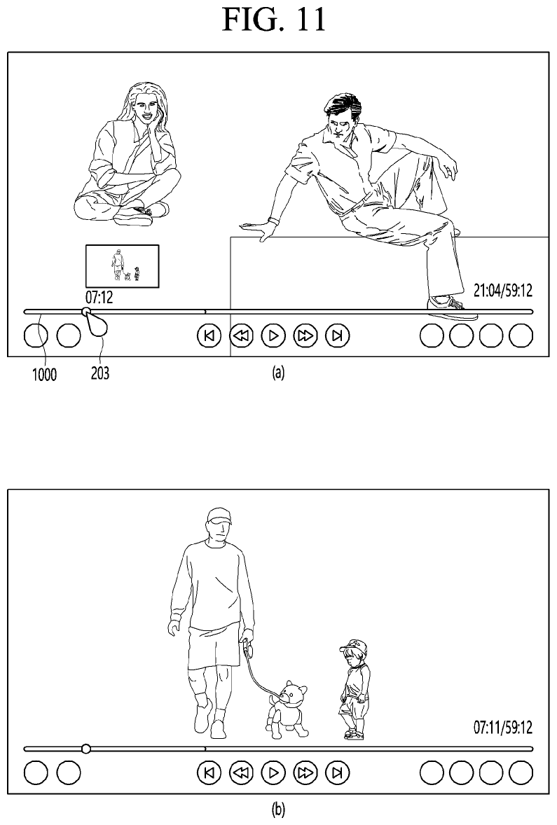

A search command may be a command that changes the playback point of an image. The control unit 170 may receive a search command by receiving a button provided on the remote control device 200 or by selecting a point on the progress bar 1000 (see FIG. 11) through the pointer 203. That is, the search command may include at least one of an input command using a direction key provided in the remote control device 200 or a command for selecting a point of the progress bar 1000.

Conventionally, when the control unit 170 receives a search command, it changes the playback point by a predetermined time. As a specific example, when receiving an input command for the left direction key of the remote control device 100, the control unit 170 changes the playback point 10 seconds forward from the current playback point and when receiving an input command for the right direction key of the remote control device 100. the control unit 170 changes the playback point backward 10 seconds back from the current playback point. However, in this case, if the changed playback point is while the characters in the image are talking, a problem of dialogue (audio) interruption may occur. Additionally, the viewer experiences the inconvenience of having to find the beginning of the conversation again.

To improve this problem, when changing the playback point of an image according to a search command, the display device 100 according to an embodiment of the present disclosure may change the playback point on a subtitle unit. In particular, while changing the playback point of an image on a subtitle unit and the display device 100 may play the image a predetermined time before the start point of the subtitle to be displayed immediately according to the changed playback point. Through this, the problem of the first part of the conversation being cut off may be effectively improved.

Hereinafter, with reference to the drawings, a method by which the display device 100 changes the playback point of an image according to a search command will be described in detail.

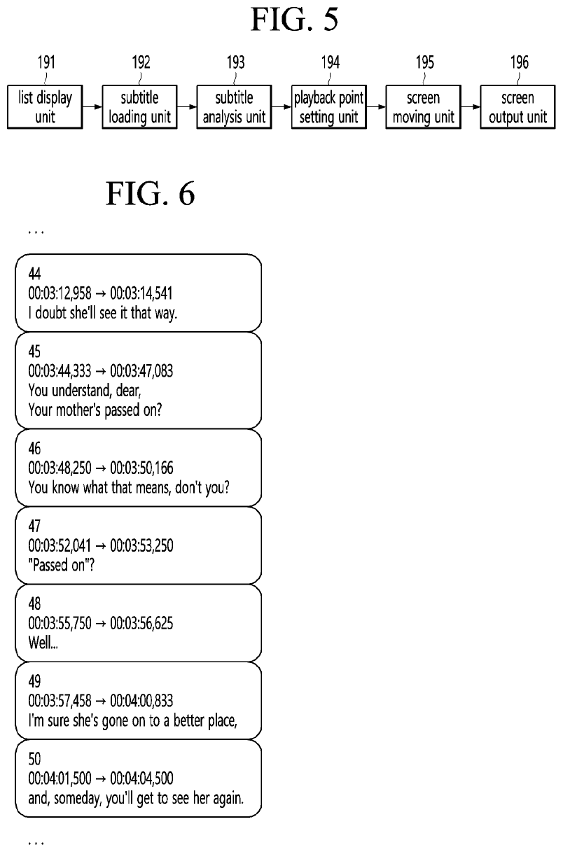

FIG. 5 is a control block diagram illustrating a method in which a display device changes the playback point of an image according to a search command according to an embodiment of the present disclosure.

The display device 100 includes at least part or all of a list display unit 191, a subtitle loading unit 192, a subtitle analysis unit 193, a playback point setting unit 194, a screen moving unit 195, and a screen output unit 196. The above-described components may be one component of the control unit 180.

The list display unit 191 may display a list listing at least one image that may be played. images listed in the list may be displayed as file name and thumbnail.

When one of the images displayed by the list display unit 191 is played, the subtitle loading unit 192 may obtain a subtitle file (e.g., smi, srt, sub, ass, etc.) that matches the image being played.

The subtitle analysis unit 193 may analyze the subtitle file acquired by the subtitle loading unit 192. Specifically, the subtitle analysis unit 193 may obtain subtitle information (e.g., timestamp, text, etc.) of all subtitles in the subtitle file. That is, the subtitle analysis unit 193 may obtain the start point and end point where each subtitle begins, and the text to be displayed.

Subtitles in a subtitle file may be managed as a subtitle sync block.

FIG. 6 is an example diagram of subtitle sync blocks constituting a subtitle file.

A subtitle file may include at least one subtitle sync block. Each subtitle sync block may include the number of the subtitle sync block, time information (i.e., timestamp) of the subtitle to be displayed, and text.

Referring to the example in FIG. 6, while the image is being played, “I doubt she'll see it that way.” may be displayed from 00:03:12,958 to 00:03:14,541 of the playback point, and “You understand, dear, Your mother's passed on?” may be displayed from 00:03:44,333 to 00:03:47,083 of the playback point, and “You know what that means, don't you?” may be displayed from 00:03:48,250 to 00:03:50,166 of the playback point, and ““Passed on”?” may be displayed from 00:03:52,041 to 00:03:53,250 of the playback point, and “Well . . . ” may be displayed from 00:03:55,750 to 00:03:56,625 of the playback point, and “I'm sure she's gone on to a better place,” may be displayed from 00:03:57,458 to 00:04:00,833 of the playback point, and “and, someday, you'll get to see her again.” may be displayed from 00:04:01,500 to 00:04:04,500 of the playback point.

Again, FIG. 5 will be described.

The playback point setting unit 194 may set the location to which the scene will be moved. That is, the playback point setting unit 194 may set the playback point to be changed by a search command. The playback point setting unit 194 may correct the playback point based on subtitle information.

The screen moving unit 195 may move the scene to the playback point set by the playback point setting unit 194. That is, the screen moving unit 195 may change the playback point of the image to the playback point set through the playback point setting unit 194.

The screen output unit 196 may display the image from the changed playback point.

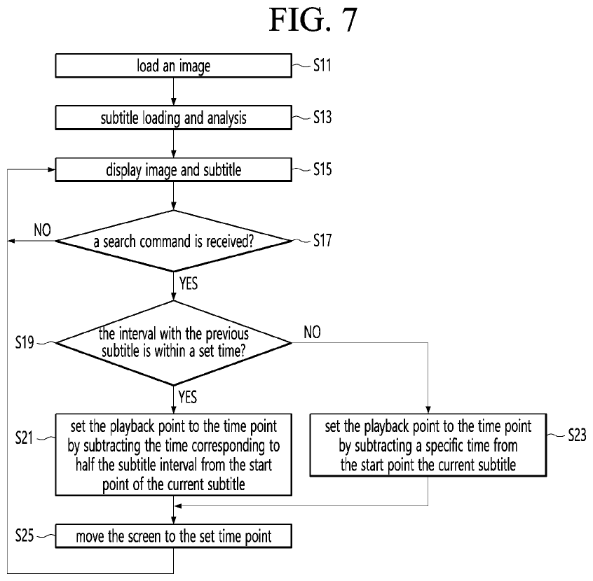

Next, with reference to FIG. 7, a method of operating a display device according to an embodiment of the present disclosure will be described. FIG. 7 is a flow chart illustrating a method of operating a display device according to an embodiment of the present disclosure.

According to an embodiment of the present disclosure, the control unit 170 may change the playback point of the image on the subtitle unit according to a search command, and at this time, change the playback point differently according to the interval between subtitles.

The control unit 170 may load an image (S11).

For example, when the control unit 170 receives a playback command for at least one image listed in the list, it may load the image according to the playback command. That is, the control unit 170 may obtain an image corresponding to a playback command and receive image data.

The control unit 170 may perform subtitle loading and analysis (S13).

The control unit 170 may load and analyze the subtitle of the image corresponding to the playback command. Specifically, the control unit 170 may acquire subtitle for an image corresponding to a playback command and receive data of the acquired subtitle. Additionally, the control unit 170 may analyze subtitle data. Subtitle data may include a subtitle file.

For example, the control unit 170 may obtain subtitles included in an image that is being loaded. The control unit 170 may obtain the timestamp and text of each subtitle included in the image.

The control unit 170 may display image and subtitle (S15).

The control unit 170 may display the acquired image and subtitle.

The control unit 170 may obtain whether a search command is received (S17).

That is, the control unit 170 may determine whether a search command is received. The search command may be a command that changes the playback point of the image. The user may change the playback point of the image through the remote control device 200. The control unit 170 may receive a search command by receiving a signal from the remote control device 200 through the user input interface unit 150.

The search command may include at least one of a first search command that changes the playback point forward, a second search command that changes the playback point back, and a third search command that changes the playback point to a specific point.

The first search command is a left key input command provided in the remote control device 200, the second search command is a right key input command provided in the remote control device 200, and the third search command may be a command to select a point on the progress bar (1000, see FIG. 11) indicating the playback point.

If the control unit 170 does not receive a search command, it may continue to display the image and subtitle.

When receiving a search command, the control unit 170 may determine whether the interval with the previous subtitle is within a set time (S19).

When receiving a search command, the control unit 170 may obtain the interval with the previous subtitle and whether the interval with the previous subtitle is within a set time.

If the interval between the current subtitle and the previous subtitle is within the set time, the control unit 170 may set the playback point to the time point by subtracting the time corresponding to half the subtitle interval from the start point of the current subtitle (S21), and set the playback point to the time point by subtracting a specific time from the start point the current subtitle if the interval between the current subtitle and the previous subtitle exceeds the set time (S23).

When the control unit 170 sets the playback point, it may move the screen to the set time point (S25).

That is, the control unit 170 may play the image from the set playback point.

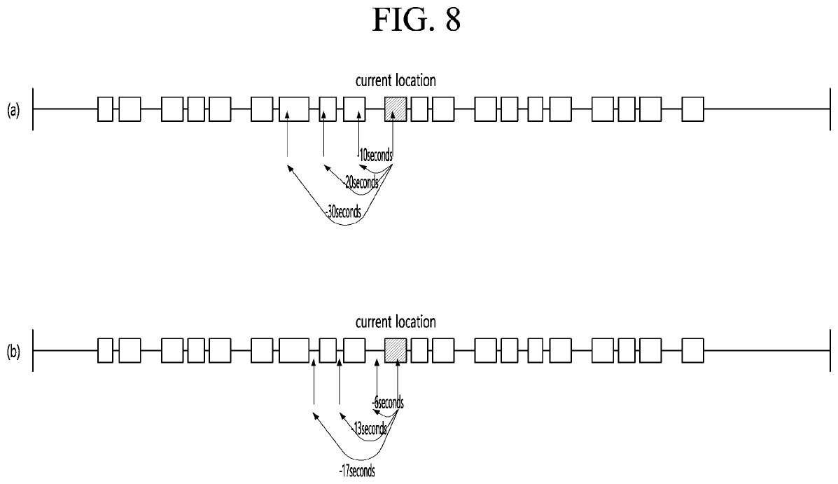

Referring to the example of FIG. 8, how the control unit 170 sets the playback point on a subtitle unit will be described in detail.

FIG. 8 is an example diagram illustrating a method by which a display device sets a playback point on a subtitle unit according to an embodiment of the present disclosure.

FIG. 8(a) is a diagram illustrating a method of changing the playback point by a fixed time when the display device 100 receives a search command, and FIG. 8(b) shows a method of changing the playback point on a subtitle unit when the display device 100 receives a search command. The square box shown in (a) and (b) of FIG. 8 represents subtitle sync block, and may be the time at which the subtitle is displayed, that is, the time at which the person in the image speaks.

In the example (a) of FIG. 8, it is assumed that the fixed time is 10 seconds. When the control unit 170 receives the first search command at the current location, the control unit 170 may change the playback point to a point minus 10 seconds from the current location. Additionally, when the control unit 170 receives the first search command at the changed point, it may change the playback point to a point minus 10 seconds from the changed location. Therefore, when the control unit 170 receives the first search command once from the current location, the control unit 170 may set the playback point to −10 seconds point from the current location, and when the control unit 170 receives the first search command twice from the current location, the control unit 170 may set the playback point to −20 seconds point from the current location, and when the control unit 170 receives the first search command three times from the current location, may set the playback point to −30 seconds point from the current location. In this case, as shown in (a) of FIG. 8, the playback point may be changed to the time corresponding to the subtitle sync block, which means that it is moved to the middle of the scene where the dialogue appears, causing the problem of dialogue interruption.

Meanwhile, in the example (b) of FIG. 8, the control unit 170 sets the playback point to a time point between subtitles. That is, according to the embodiment of the present disclosure, the control unit 170 sets the playback point to a time point between subtitles. When the control unit 170 receives the first search command at the current location, the control unit 170 may set a point between the subtitle sync block according to the current playback location and the previous subtitle sync block as the playback point. In this way, the time taken to move to the playback point by the first search command may be different. According to the example in (b) of FIG. 8, when the control unit 170 receives the first search command once, it may set the playback point at −6 seconds point from the current location, and when it receives the first search command twice, it may set the playback point at −13 seconds point from the current location and when it receives the first search command three times, it may set the playback point at the −17 second point from the current location. Meanwhile, 6 seconds, 13 seconds, 17 seconds, etc. are just examples to explain that the playback point moved when the playback point is changed is different.

As explained through (b) of FIG. 8, when the control unit 170 changes the playback point on a subtitle unit, there is an advantage in that the problem of dialogue interruption is minimized.

Meanwhile, when the control unit 170 changes the playback point on a subtitle unit and changes the playback point to the start point of each subtitle, the dialogue may start immediately and the first part of the dialogue may be missed. Accordingly, the control unit 170 may change the playback point to a predetermined time before the start point of each subtitle. However, if the interval between subtitles is short, the point a predetermined time before the start point of a specific subtitle may correspond to the previous subtitle. Accordingly, the control unit 170 changes the playback point to a predetermined time before the start point of each subtitle, but changes the playback point to a time that does not overlap with the previous subtitle. Accordingly, according to an embodiment of the present disclosure, the control unit 170 may change the playback point differently based on the interval between subtitles.

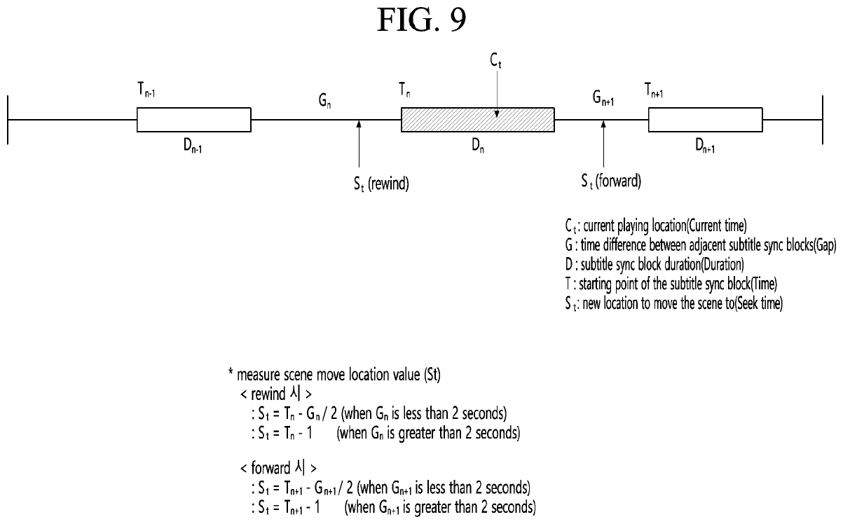

Referring to FIG. 9, we will explain a method of changing the playback timing differently based on the interval between subtitles. In particular, we will explain in detail how to set a specific point between subtitles as the playback point. FIG. 9 is a diagram illustrating a method of changing the playback location on a subtitle unit according to an embodiment of the present disclosure.

As shown in FIG. 9, Ct refers to the current playing location (Current time), G refers to the interval between subtitles as the time difference (Gap) between adjacent subtitle sync blocks, and D refers to the subtitle sync block duration, T refers to the starting point (Time) of the subtitle sync block, and St refers to the new location to move the scene to (Seek time), which may refer to the playback point changed by the search command.

If the search command is the first search command that changes the playback point forward than the current point, the control unit 170 may change the playback point from the start point of the current subtitle to a time before a reference time. If the search command is a second search command that changes the playback point later than the current point, the control unit 170 may change the playback point from the start point of the next subtitle to a time before the reference time. That is, in the example of FIG. 9, the control unit 170 may change the playback point from Ct to St (rewind) when receiving the first search command, and may change the playback point from Ct to St (forward) when receiving the second search command.

The reference time may mean a playback point changed according to a search command. The reference time may be adjusted according to the interval between subtitles.

The control unit 170 may adjust the reference time based on the interval between subtitles. More specifically, the control unit 170 may compare the interval between subtitles with the set time and adjust the reference time based on a comparison result.

The setting time is a predetermined time and may be 2 seconds, but since this is only an example, it is reasonable that it is not limited thereto.

If the interval between subtitles is less than the set time, the control unit 170 may set the reference time to a time corresponding to half the interval between subtitles. For example, if the interval between subtitles is 1.6 seconds and the setting time is 2 seconds, the control unit 170 may set the reference time to 0.8 seconds.

In summary, when receiving the first search command, if the inter-subtitle interval (Gn) is less than the set time, the control unit 170 may change the playback point St to a point (Tn−Gn/2) by subtracting half (Gn/2) of the inter-subtitle interval from the start point (Tn) of the subtitle corresponding to the current playback point. when receiving the second search command, if the inter-subtitle interval (Gn+1) is less than the set time, the control unit 170 may change the playback point St to a point (Tn+1−Gn+½) by subtracting half (Gn+½) of the inter-subtitle interval from the start point (Tn+1) of the following subtitle.

Meanwhile, if the interval between subtitles is longer than the set time, the control unit 170 may set the reference time to a time corresponding to a preset constant (for example, 1). For example, if the interval between subtitles is 3 seconds and the setting time is 2 seconds, the control unit 170 may set the reference time to 1 second.

In summary, when receiving the first search command, if inter-subtitle interval (Gn) exceeds the set time, the control unit 170 may change the playback point St to a point (Tn−1) by subtracting a time (e.g. 1 second) corresponding to a predetermined constant from the start point (Tn) of the subtitle corresponding to the current playback point. when receiving the second search command, if inter-subtitle interval (Gn+1) exceeds the set time, the control unit 170 may change the playback point St to a point (Tn+1−1) by subtracting a time (e.g. 1 second) corresponding to a predetermined constant from the start point (Tn+1) of a following subtitle.

In this way, when the control unit 170 changes the playback point by adjusting the reference time based on the inter-subtitle interval, there is an advantage in that the playback point may be changed to the point corresponding to the inter-subtitle interval, that is, between lines. Specifically, according to the method shown in FIG. 9, when the interval between lines is long, the playback point is changed to a few seconds before the next line, and when the interval between lines is short, the playback point is changed to the middle, so there is an advantage in that the playback point is changed to a location where dialogue breaks do not occur.

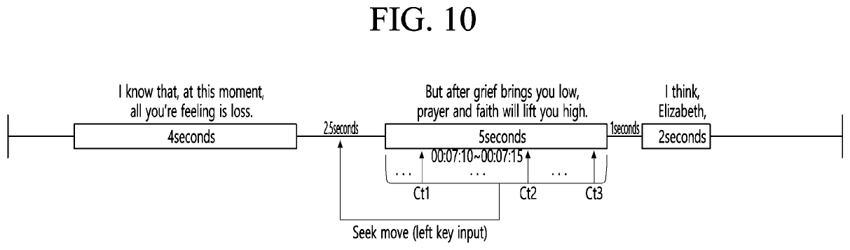

FIG. 10 is a diagram showing how the playback location changes between lines when a search command is received according to an embodiment of the present disclosure.

The square box shown in FIG. 10 is subtitle sync block, and the subtitle time and text for each subtitle sync block is shown.

When the playback location is the first playback location (Ct1) and the first search command is received, the control unit 170 may change the playback location from the start point of the subtitle corresponding to the first playback location (Ct1) to a point before the reference time, when the playback location is the second playback location (Ct2) and the first search command is received, the control unit 170 may change the playback location from the start point of the subtitle corresponding to the second playback location (Ct2) to a point before the reference time, and when the playback location is the third playback location (Ct3) and the first search command is received, the control unit 170 may change the playback location from the start point of the subtitle corresponding to the third playback location (Ct3) to a point before the reference time.

That is, according to an embodiment of the present disclosure, if the subtitles being displayed at the time the search command is received are the same, the changed playback location may be the same. Therefore, there is an advantage in that users who want to listen to specific lines repeatedly, especially users who want to listen to specific lines repeatedly for language study purposes, may easily set the playback location.

Meanwhile, even when the playback location is specified through the pointer 203, etc., the control unit 170 may set the playback location so that the line is not played from the middle of the line.

FIG. 11 is an example diagram illustrating a method of setting a playback location in a display device according to an embodiment of the present disclosure to minimize the problem of dialogue interruption when the playback location is specified.

As shown in (a) of FIG. 11, the control unit 170 may receive a search command for selecting a point on the progress bar 1000 through the pointer 203. In (a) of FIG. 11, the point selected through the search command may be 07:12. The control unit 170 may obtain the subtitle closest to the selected point and change the starting point of the obtained subtitle to the playback point. For example, the control unit 170 may change the playback point to 07:11, which is the start point of the subtitle closest to the selected point, as shown in (b) of FIG. 11, although the selected point is 07:12.

In this way, according to the embodiment of the present disclosure, even if a specific point is selected through the pointer 203, the problem of playing back the from the middle of dialogue may be minimized.

Meanwhile, the display device 100 according to an embodiment of the present disclosure may provide a plurality of operation modes so that the method of setting the playback location according to the search command may be set in various ways depending on the purpose of the image, etc.

For example, the display device 100 may provide a subtitle search mode and a general search mode, and operate in a mode selected from the subtitle search mode and the general search mode.

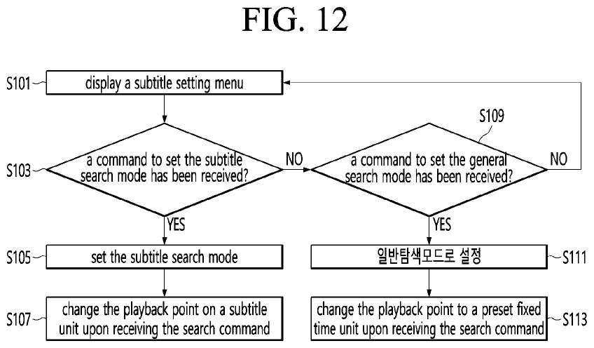

FIG. 12 is a flowchart illustrating a method by which a display device sets a method of changing a playback location according to a search command according to an embodiment of the present disclosure.

The control unit 170 may display a subtitle setting menu (S101).

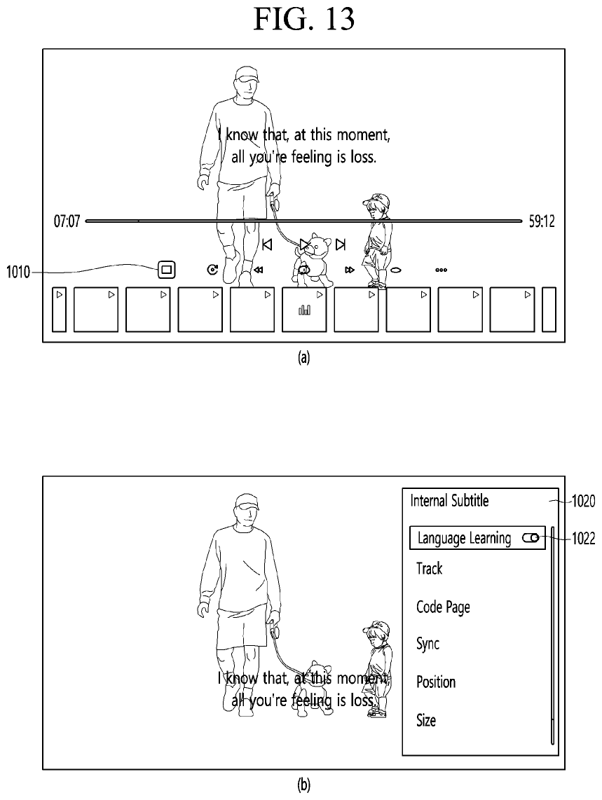

FIG. 13 is an example diagram illustrating a method of displaying a subtitle setting menu by a display device according to an embodiment of the present disclosure.

The control unit 170 may display the subtitle setting icon 1010 when displaying the playback control screen. The subtitle setting icon 1010 may be displayed as shown in (a) of FIG. 13, but since this is only an example, it is reasonable that it is not limited thereto.

When the subtitle setting icon 1010 is selected, the control unit 170 may display the subtitle setting menu 1020. The subtitle setting menu 1020 may be a menu for selecting either a subtitle search mode or a general search mode.

As an example, the subtitle setting menu 1020 may include an item (not shown) for setting a subtitle search mode or general search mode.

As another example, the subtitle setting menu 1020 may include a language function setting item 1022. The control unit 170 may turn the language function on or off according to a command for selecting the language function setting item 1022. The control unit 170 may set the subtitle search mode when the language study function is on, and set it to the general search mode when the language study function is off.

That is, the control unit 170 may display a menu for selecting either the subtitle search mode or the general search mode in various ways.

Again, FIG. 12 will be described.

The control unit 170 may determine whether a command to set the subtitle search mode has been received (S103). When receiving a command to set the subtitle search mode, the control unit 170 sets the subtitle search mode (S105) and changes the playback point on a subtitle unit upon receiving the search command (S107).

When the subtitle search mode is set, the control unit 170 may change the image playback point on a subtitle unit. That is, when the subtitle search mode is set, the control unit 170 may change the playback point of the image by the method described in FIGS. 7 to 11 ((b) of FIG. 8 in FIG. 8).

Meanwhile, if the control unit 170 does not receive a command to set the subtitle search mode, it may determine whether a command to set the general search mode has been received. When receiving a command to set the normal search mode, the control unit 170 sets the normal search mode (S111) and changes the playback point to a preset fixed time unit upon receiving the search command (S113).

When the general search mode is set, the control unit 170 may change the image playback point in preset fixed time unit. That is, when the general search mode is set, the control unit 170 may change the image playback point in the preset fixed time unit (for example, 10 seconds), as described in (a) of FIG. 8.

As such, in the present disclosure, the method by which the playback point is changed may vary depending on the set operation mode. That is, according to the present disclosure, there is an advantage that the method of changing the playback point of view may be set differently depending on the purpose of the image.

Meanwhile, according to an embodiment of the present disclosure, a method for changing the playback point may be automatically set depending on the purpose of the image. That is, according to an embodiment of the present disclosure, the display device 100 may automatically change the method of changing the playback point by acquiring the purpose of playing the image and automatically setting the operation mode accordingly. Alternatively, the display device 100 may obtain the purpose of playing the image and output a notification to change the operation mode accordingly.

According to one embodiment, the control unit 170 may obtain the purpose of playing the image based on the language of the audio and the language of the subtitles output as the image is played. That is, the control unit 170 may change the operation mode or output a notification to change the operation mode based on the audio language and subtitle language.

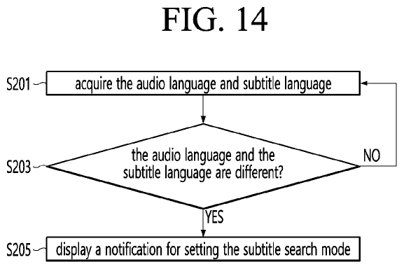

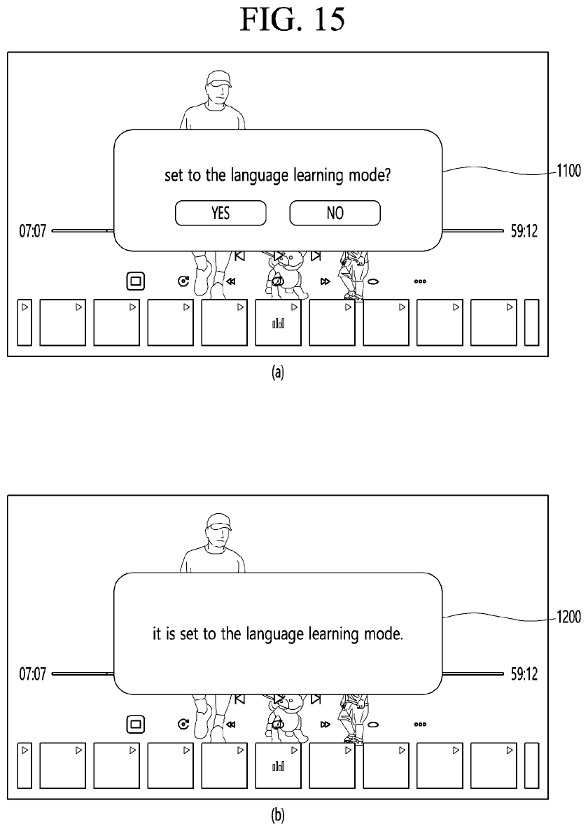

FIG. 14 is a flowchart illustrating a method of outputting a notification by a display device according to an embodiment of the present disclosure to induce a change in the operation mode based on the audio language and subtitle language, and FIG. 15 is a flowchart of a display device according to an embodiment of the present disclosure. This is an example diagram showing a notification output based on the audio language and subtitle language.

Referring to FIG. 14, the control unit 170 may acquire the audio language and subtitle language (S201).

The control unit 170 may obtain whether the audio language and the subtitle language are different (S203).

That is, the control unit 170 may obtain whether the audio language and the subtitle language match.

If the audio language and the subtitle language are different, the control unit 170 may display a notification for setting the subtitle search mode (S205).

If the language of the audio output according to the image and the language of the subtitle are different, the control unit 170 may display a notification of setting the search mode in which the playback point of the image changes on the subtitle unit. Specifically, if the audio language and the subtitle language are different, the control unit 170 may recognize that the user is watching the image for language learning purpose. Accordingly, if the audio language and the subtitle language are different, the control unit 170 may display a notification for setting the subtitle search mode.

Meanwhile, for language study purpose, whether or not to match the subtitle language with the audio language may depend on the user's choice.

Therefore, according to another embodiment, if the language of the audio output according to the image and the language of the subtitle are the same, the control unit 170 may display a notification of setting the search mode in which the playback point of the image changes on the subtitle unit. That is, unlike FIG. 14, if the audio language and the subtitle language match, the control unit 170 may recognize that the image is played for language learning purpose. Accordingly, if the audio language and the subtitle language are the same, the control unit 170 may display a notification for setting the subtitle search mode.

Next, referring to FIG. 15, a method of displaying a setting notification for the subtitle search mode will be described.

As shown in (a) of FIG. 15, according to an embodiment of the present disclosure, the control unit 170 displays a pop-up 1100 to select whether to set to the language learning mode, thereby notification for setting the subtitle search mode may be displayed. The control unit 170 may select whether to set the language learning mode in the pop-up 1100 through the pointer 203, and may set it to the subtitle search mode or the general search mode according to the selection input.

As shown in (b) of FIG. 15, according to another embodiment of the present disclosure, the control unit 170 automatically sets the subtitle search mode and displays a message 1200 indicating that it is set to the language learning mode, a notification for setting the subtitle search mode may be displayed.

According to an embodiment of the present disclosure, the display device 100 automatically sets the language learning mode, thereby minimizing the user's inconvenience in setting the language function separately.

The present disclosure described above may be implemented as computer-readable code on a program-recorded medium. Computer-readable media includes all types of recording devices that store data that may be read by a computer system. Examples of computer-readable media include HDD (Hard Disk Drive), SSD (Solid State Disk), SDD (Silicon Disk Drive), ROM, RAM, CD-ROM, magnetic tape, floppy disk, optical data storage device, etc. Additionally, the computer may include a control unit 170 of the display device 100. Accordingly, the above detailed description should not be construed as restrictive in all respects and should be considered illustrative. The scope of this specification should be determined by reasonable interpretation of the appended claims, and all changes within the equivalent scope of this specification are included in the scope of this specification.

The above description is merely an illustrative explanation of the technical idea of the present invention, and various modifications and variations will be possible to those skilled in the art without departing from the essential characteristics of the present invention.

Accordingly, the embodiments disclosed in the present invention are not intended to limit the technical idea of the present invention, but rather to explain it, and the scope of the technical idea of the present invention is not limited by these embodiments.

The scope of protection of the present invention should be interpreted in accordance with the claims below, and all technical ideas within the equivalent scope should be construed as being included in the scope of rights of the present invention.

What is claimed is:

1. A display device, comprising:
a display configured to display an image and a subtitle corresponding to the image; and
a control unit configured to receive a search command for changing a playback point of the image,
wherein the control unit is further configured to:
change the playback point of the image to a subtitle unit according to the search command, and
change the playback point differently according to an inter-subtitle interval.

2. The display device of claim 1, wherein the control unit is configured to change the playback point from a start point of a current subtitle to a point before a reference time when the search command is a first search command that changes the playback point forward than a current point.

3. The display device of claim 1, wherein the control unit is configured to change the playback point from a start point of a following subtitle to a point before a reference time when the search command is a second search command that changes the playback point backward than a current point.

4. The display device of claim 1, wherein the control unit is configured to:
change the playback point from a start point of a current subtitle to a point before a reference time, when the search command is a first search command that changes the playback point forward than a current point, and
change the playback point from a start point of a following subtitle to a point before the reference time when the search command is a second search command that changes the playback point backward than the current point.

5. The display device of claim 4, wherein the control unit is further configured to adjust the reference time based on the inter-subtitle interval.

6. The display device of claim 5, wherein the control unit is further configured to:
set the reference time to a time corresponding to half of the interval when the inter-subtitle interval is less than a set time, and
set the reference time to a time corresponding to a preset constant when the inter-subtitle interval is longer than the set time.

7. The display device of claim 4, wherein the first search command is a left key input command provided in the remote control device, and the second search command is a right key input command provided in the remote control device.

8. The display device of claim 1, wherein the control unit is configured to change the playback point to a start point of a subtitle closest to a selected point when the search command is a command to select a point on a progress bar indicating the playback point.

9. The display device of claim 1, wherein the control unit is further configured to display a menu for selecting either a subtitle search mode or a general search mode.

10. The display device of claim 9, wherein the control unit is configured to:
change the playback point of the image to the subtitle unit when the subtitle search mode is set, and
change the playback point of the image to a preset fixed time unit when the general search mode is set.

11. The display device of claim 1, wherein the control unit is further configured to:
display a notification of setting a search mode in which the playback point of the image is changed to the subtitle unit when a language of an audio output according to the image and a language of the subtitle are different.

12. The display device of claim 1, wherein the control unit is further configured to:
display a notification of setting a search mode in which the playback point of the image is changed to the subtitle unit when a language of an audio output according to the image and a language of the subtitle are same.
